(19) United States
(12) Patent Application Publication
(10) Pub. No.: US 2014/0109015 A1
(43) Pub. Date: Apr. 17, 2014

(54) CONFIGURABLE HIERARCHICAL TREE VIEW

(71) Applicant: INTERNATIONAL BUSINESS MACHINES CORPORATION, ARMONK, NY (US)

(72) Inventor: BRIAN G. FARN, TORONTO (CA)

(73) Assignee: INTERNATIONAL BUSINESS MACHINES CORPORATION, ARMONK, NY (US)

(21) Appl. No.: 14/133,987

(22) Filed: Dec. 19, 2013

Related U.S. Application Data
(63) Continuation of application No. 13/349,618, filed on Jan. 13, 2012, now abandoned.

(30) Foreign Application Priority Data
Feb. 24, 2011 (CA) 2732643

(51) Int. Cl. G06F 3/0484

(52) U.S. Cl. CPC G06F 3/0484
USPC 715/854

(57) ABSTRACT

A view is created that includes nodes in a serial sequence of nodes. Hierarchical tree data is received. It can be determined whether a node is a start node of a serial sequence of nodes. Responsive to a determination that the node is a start node of a serial sequence of nodes a collapse control of the start node in the serial sequence of nodes is changed to a collapsed state. The computer-implemented process counts intervening nodes between the start node and an end node of the serial sequence of nodes to form a count, hides the intervening nodes to form hidden intervening nodes, creates a segment using the start node with collapse control and the end node using the count in place of the hidden intervening nodes and creates the view using the segments.

### CROSS-REFERENCE TO RELATED APPLICATIONS

This application claims the benefit of U.S. application Ser. No. 13/349,618 filed 13 Jan. 2012, which claims the benefit of Canadian application application number is 2732643, which was filed on Feb. 24, 2011. The teachings of the parent case (application Ser. No. 13/349,618) and its Canadian parent (Application 2732643) are hereby incorporated by reference in their entirety.

### BACKGROUND

A tree hierarchy may have one or more sequences of nodes where a parent node has a single child node, which is also a parent node that has a single child node. A visual horizontal representation of a hierarchy with many long serial sequences can result in the presentation of an overwhelming number of nodes. Models exist in which the most valuable information resides at the beginning and end of each serial sequence. For instance, a function call stack of a single threaded software program may be represented as a serial sequence of nodes with the bottom of the stack as a parent of the next entry in the stack, and so on until the top of the stack is reached.

The most valuable entries in the call stack are the bottom entry, which indicates how the program was started, as well as the top of the stack, which indicates a function at the current location within the program. Of less interest or value are entries leading up to the top of the stack, which comprises the function invocation path leading to the function at the current location within the program. All other entries in the call stack have a lower interest or value.

A useful visual presentation of a tree hierarchy typically considers the importance of information a user needs to view when the hierarchy of data is initially presented and a capability for a user to configure the amount of detailed information shown.

### BRIEF SUMMARY

According to one embodiment, a computer-implemented process for creating a view including nodes in a serial sequence of nodes receives hierarchical tree data, determines whether a node is a start node of a serial sequence of nodes. Responsive to a determination that the node is a start node of a serial sequence of nodes a collapse control of the start node in the serial sequence of nodes is changed to a collapsed state. The computer-implemented process counts intervening nodes between the start node and an end node of the serial sequence of nodes to form a count, hides the intervening nodes to form hidden intervening nodes, creates a segment using the start node with collapse control and the end node using the count in place of the hidden intervening nodes and creates the view using the segments.

According to another embodiment, a computer program product for creating a view including nodes in a serial sequence of nodes comprises a computer recordable-type media containing computer executable program code stored thereon. The computer executable program code comprises computer executable program code for receiving hierarchical tree data, computer executable program code for determining whether a node is a start node of a serial sequence of nodes, computer executable program code responsive to a determination that the node is a start node of a serial sequence of nodes for changing a collapse control of the start node in the serial sequence of nodes to a collapsed state, computer executable program code for counting intervening nodes between the start node and an end node of the serial sequence of nodes to form a count, computer executable program code for hiding the intervening nodes to form hidden intervening nodes, computer executable program code for creating a segment using the start node with collapse control and the end node using the count in place of the hidden intervening nodes and computer executable program code for creating the view using the segments.

According to another embodiment, an apparatus for creating a view including nodes in a serial sequence of nodes comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to receive hierarchical tree data, and determine whether a node is a start node of a serial sequence of nodes. The processor unit executes the computer executable program code responsive to a determination that the node is a start node of a serial sequence of nodes, to direct the apparatus to change a collapse control of the start node in the serial sequence of nodes to a collapsed state, count intervening nodes between the start node and an end node of the serial sequence of nodes to form a count, hide the intervening nodes to form hidden intervening nodes, create a segment using the start node with collapse control and the end node using the count in place of the hidden intervening nodes and create the view using the segments.

### BRIEF DESCRIPTION OF THE SEVERAL VIEWS OF THE DRAWINGS

FIG. 1 is a block diagram of a data processing system network operable for various embodiments of the disclosure;

FIG. 2 is a block diagram of a data processing system operable for various embodiments of the disclosure;

FIG. 3 is a block diagram of a view system, in accordance with various embodiments of the disclosure;

FIG. 4 is a block diagram of a regular view of an embodiment of the disclosure;

FIG. 5 is a block diagram of a regular view with collapsed nodes of an embodiment of the disclosure;

FIG. 6 is a block diagram of views with collapsed nodes including a serial sequence of nodes, in accordance with various embodiments of the disclosure;

FIG. 7 is a block diagram of views with collapsed nodes including a serial sequence of nodes, in accordance with various embodiments of the disclosure;

FIG. 8 is a block diagram of a summary view of nodes including a serial sequence of nodes, in accordance with various embodiments of the disclosure;

FIG. 9 is a block diagram of summary views of nodes including a serial sequence of nodes, in accordance with various embodiments of the disclosure;

FIG. 10 is a flowchart of a process for creating a view using a serial sequence of nodes of FIG. 6, in accordance with various embodiments of the disclosure;

FIG. 11 is a flowchart of a process for creating a summary view including a serial sequence of nodes of FIG. 10, in accordance with various embodiments of the disclosure; and

FIG. 12 is a flowchart of a process for creating a view displaying additional node information using a serial sequence of nodes of FIG. 10, in accordance with various embodiments of the disclosure.

### DETAILED DESCRIPTION

The disclosure is now described within the context of one or more embodiments, although the description is intended to be illustrative of embodiments of the invention as a whole, and is not to be construed as limiting other embodiments of the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

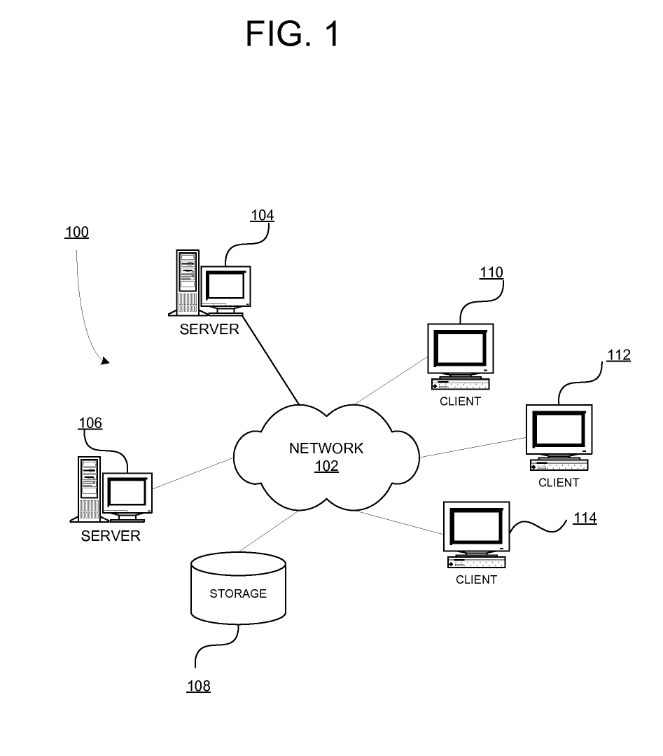

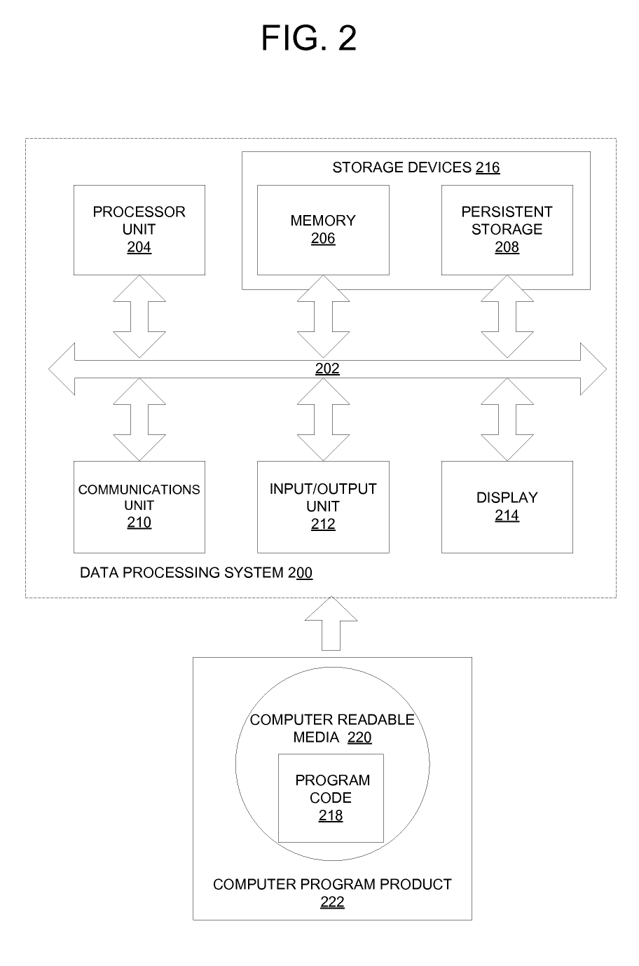

With reference now to the FIG.s and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference to FIG. 2 a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

Using data processing system 200 of FIG. 2 as an example, a computer-implemented process for creating summary views of nodes in a serial sequence of nodes is presented. Processor unit 204 receives hierarchical tree data typically using communications unit 210, input/output unit 212 or storage devices 216. Processor unit 204 determines whether a summary view state exists and responsive to a determination that the summary view state exists, determines whether a node is a start node of a serial sequence of nodes. Responsive to a determination that the node is a start node of a serial sequence of nodes, processor unit 204 changes a collapse control of the start node in the serial sequence of nodes to a collapsed state, counts intervening nodes between the start node and an end node of the serial sequence of nodes to form a count and hides the intervening nodes to form hidden intervening nodes. Processor unit 204 creates a segment using the start node with collapse control and the end node using the count in place of the hidden intervening nodes and creates a view using the segment. Processor unit 204 displays the view using display 214, stores the view in storage devices 216 or sends the view using communications unit 212 over a network such as network 102 to client 114 both of data processing system 100 of FIG. 1.

In another example, a computer-implemented process, using program code 218 stored in memory 206 or as a computer program product 222, for creating summary views of nodes in a serial sequence of nodes comprises a computer recordable storage media, such as computer readable media 220, containing computer executable program code stored thereon. The computer executable program code comprises computer executable program code for creating a view including nodes in a serial sequence of nodes.

In another illustrative embodiment, the process for creating a view including nodes in a serial sequence of nodes may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to create a view including nodes in a serial sequence of nodes.

Embodiments of the disclosure describe a process providing a capability for an initial presentation of a tree hierarchy, which displays the most valuable information including the structure of the hierarchy and all leaves of the hierarchy, and for a user to configure. the amount of detail shown for serial sequences in the viewed hierarchy.

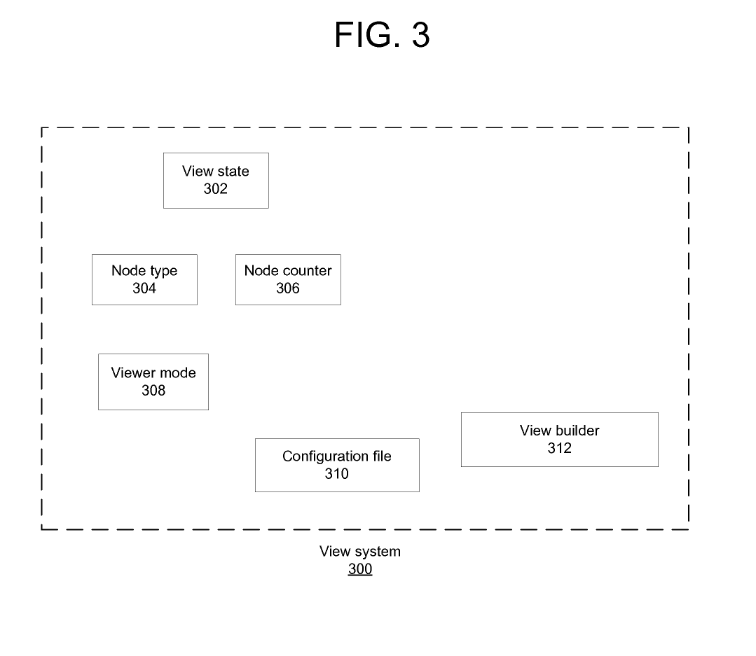

With reference to FIG. 3, a block diagram of view system, in accordance with various embodiments of the disclosure is presented. View system 300 is an example of an enhanced presentation view system for displaying information using serial collapsed and summary view states in a hierarchical tree view representation.

Embodiments of the disclosure such as view system 300 provide a capability for an initial presentation of a tree hierarchy, which displays the most valuable information including the structure of the hierarchy and all leaves of the hierarchy, and for a user to configure the amount of detail shown for serial sequences in the viewed hierarchy.

View system 300 builds upon the framework of a data processing system such as data processing system 200 of FIG. 2 and contains a number of components comprising view state 302, node type 304, node counter 306, viewer mode 308, configuration file 310 and view builder 312.

View state 302 is a data structure providing a capability to store an indicator of which state a view is to be processed. For example, when a regular view is required view state 302 may be set to a value of off while when a summary view is required view state 302 may be set to a value of on.

Node type 304 is a data structure providing a capability to determine and store and indicator of which type of node structure is to be processed. For example, node type 304 can contain a value indicating a representation of one of three types of node structures. Typical node types represented include a type of node structure with multiple children, a type of node structure with a single child but no grandchild and a type of node structure that is a sequence of nodes.

Node counter 306 is a data structure providing a capability to contain a value representing the number of hidden nodes. Hidden nodes are nodes representing children and descendants of a collapsed node. A collapsed node is a node having descendants, which are hidden, and typically includes a visual indicator enabling a user to know the node has a property of additional nodes.

Viewer mode 308 is a data structure providing a capability to indicate an addition to the particular view mode. For example, viewer mode 308 can be set off to indicate normal use of a graphic mode in which node information is presented in a pictorial or graphic presentation and set on to indicate additional use of a list information when a portion of the node information is presented using a textual list format.

Configuration file 310 is a data structure containing selectable information used to control processing and presentation properties of view system 300. For example, defaults can be set for view state and view mode as well as a number of entries to display before and after a node of interest.

View builder 312 provides a capability to create views comprising contracted nodes, series of nodes, summary views, regular views of data relationships in the form of a tree hierarchy or a subset of a tree hierarchy. The views are created for data of interest using the information managed by and contained within previously mentioned components.

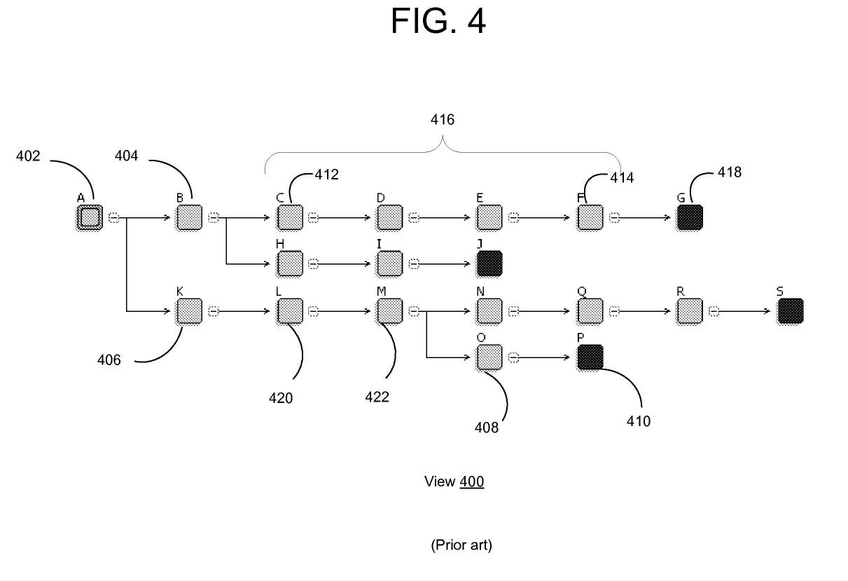

With reference to FIG. 4, a block diagram of a regular view is presented. View 400 is an example of a current view representation of a parent/child node hierarchy presented as a horizontal tree.

Each node in view 400 is visually represented. An expand/collapse control resides adjacent to all nodes with the exception of leaf nodes (nodes with no child nodes). The expand/collapse control allows a user to selectively show or hide parts of the tree. In the example are three distinct types of node structures. One type of node structure contains nodes with multiple children. For example, node A 402 is a parent with multiple child nodes such as node B 404 and node K 406. Another type of node is a node with a single child node but no grandchild nodes. For example, node O 408 is a parent node with a single child node P 410 that in turn does not have any child nodes.

Another type of node is a sequence of nodes. For example, node C 412 through node F 414 is a sequence 416 of nodes where each node is a parent node with a single child node. Node G 418 terminates sequence 416 and is a leaf node.

Node K 406 and node L 420 define a sequence of nodes where each node is a parent node with a single child node. Node M 422 terminates the sequence and has multiple child nodes.

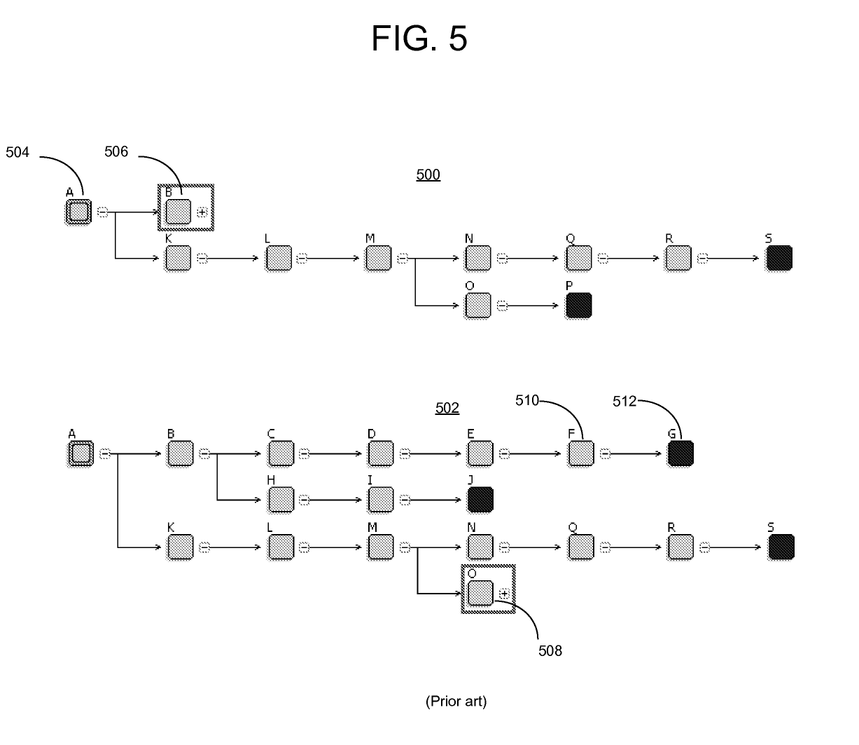

With reference to FIG. 5, a block diagram of a regular view with collapsed nodes is presented. View 500 is a further example of view 400 of FIG. 4 with representation of collapsed nodes.

For each of the types of node structures depicted in view 400 of FIG. 4 a collapse behavior is defined. In a first type of node structure of nodes with multiple children the collapsed behavior is as it is in existing art in which the children and descendants of the collapsed node are hidden. View 500 illustrates node A 504 with node B 506 in which node B 506 is in a collapsed state. Previously visible descendants of node B 506, (for example, nodes labeled C through J of view 400 of FIG. 4) are no longer visible but still exist. An indicator is provided adjacent to a collapsed node to indicate presence of hidden nodes associated with the collapsed node.

In view 502 node structures representing nodes with a single child but no grandchildren also with collapsed behavior as in the existing art is presented. Node O 508 is shown in a collapsed state. Child node P 410 of FIG. 4 is hidden. Similarly, when node F 510 is collapsed, then node G 512 is hidden.

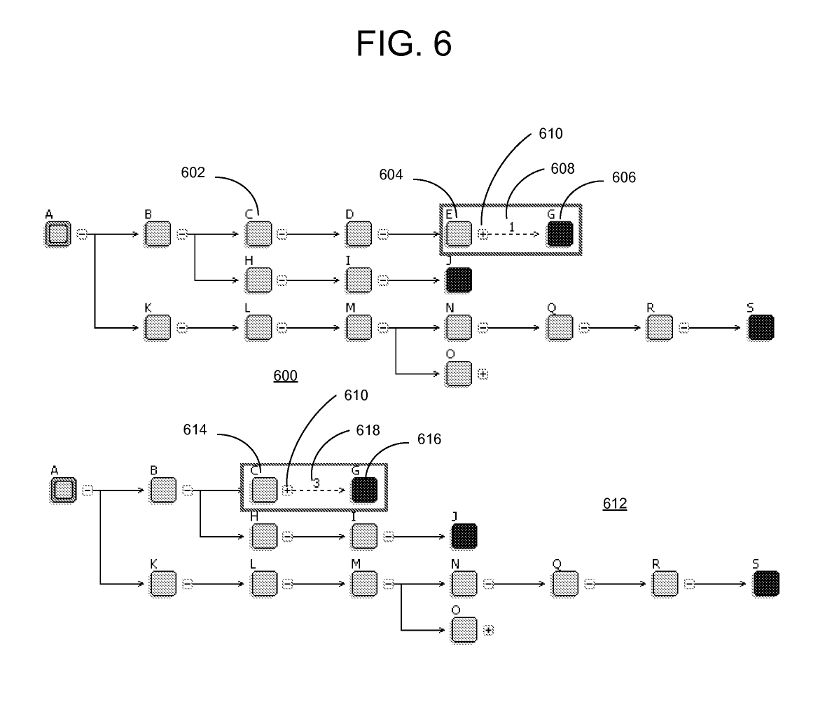

With reference to FIG. 6, a block diagram of views with collapsed nodes in a serial sequence of nodes, in accordance with various embodiments of the disclosure is presented. View 600 and view 612 are further examples of view 400 of FIG. 4 with representation of collapsed nodes in a serial sequence of nodes in accordance with various embodiments of the disclosure.

In a serial sequence of nodes when a node within a serial sequence is collapsed, nodes following the collapsed node are hidden with the exception of a last node of the serial sequence. Consider a node sequence of node C 602 through node G 606. When node E 604 is collapsed collapse control 610 is changed to indicate a collapsed state. A node F located between node E 604 and node G 606 is hidden. Node G 606, a leaf node, remains visible. A number is shown, hidden nodes 608, which indicates the number of hidden nodes in the respective sequence of nodes including node E 604 through node G 606. When the collapsed node of node E 604 is expanded, each node in the sequence is set to an expanded state as shown in FIG. 4.

In view 612 when node C 614 is collapsed collapse control 610 is changed to indicate a collapsed state. Nodes between node C 614 and node G 616 are hidden while node G 616, a leaf node, remains visible. A number is shown, hidden nodes 618, which indicates there are three hidden nodes in the current sequence. When the collapsed node of node C 614 is expanded, each node in the sequence is set to an expanded state shown FIG. 4.

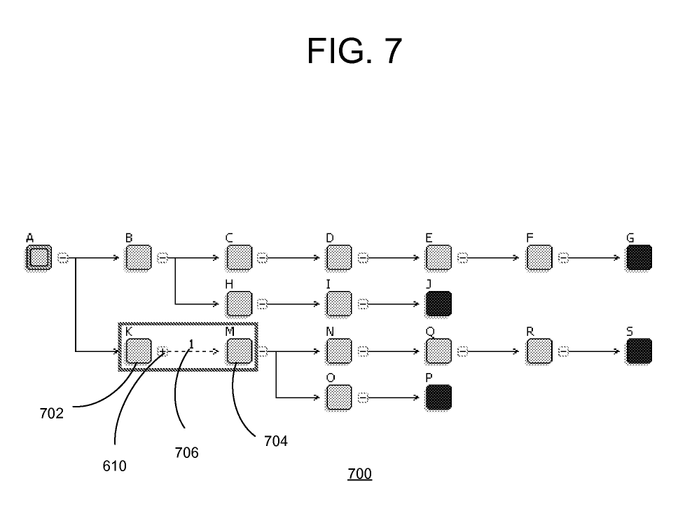

With reference to FIG. 7, a block diagram of views with collapsed nodes in a serial sequence of nodes, in accordance with various embodiments of the disclosure is presented. View 700 is a further example of view 400 of FIG. 4 with representation of collapsed nodes in a serial sequence of nodes in accordance with various embodiments of the disclosure.

In view 700 a node sequence of node K 702 through node M 704 is presented. When node K 702 is collapsed collapse control 610 is changed to indicate a collapsed state. A node L exists between node K 702 and node M 704 but is hidden. Node M 704 and associated child hierarchy remains visible.

A number is shown, hidden nodes 706, which indicates the number of hidden nodes in the current sequence. When the collapsed node of node K 702 is expanded, each node in the sequence is set to an expanded state as previously shown in FIG. 4.

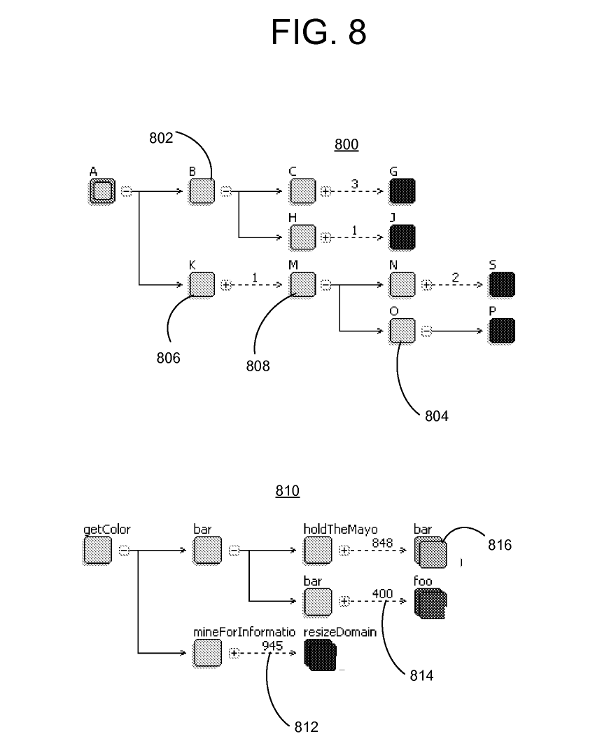

With reference to FIG. 8, a block diagram of a summary view including a serial sequence of nodes, in accordance with various embodiments of the disclosure is presented. View 800 and view 810 are further example of view 400 of FIG. 4 with representation of collapsed nodes in a serial sequence of nodes in accordance with various embodiments of the disclosure.

In a summary view state when a tree hierarchy is initially presented, nodes of the visual tree can first be set to a combination of expanded and collapsed states. Using a combination of expanded and collapsed states enables the structure of the hierarchy to be obvious to the user of the view in which serial sequences are collapsed while allowing all leaf nodes to be visible to the user.

This combination of expanded and collapsed node states is referred to as a summary view state in this disclosure. The disclosed summary state enables a user to see the most important aspects of the hierarchy.

View 800 illustrates a sample hierarchy in a summary view state. Rules for creating a summary view state for each node structure type are construed using the following examples. Nodes with multiple children, such as node 802 and node 808, are set to an expanded state. Nodes, such as node 804, with a single child that is a leaf node are also set to an expanded state. The first node, node 806, in a serial sequence of nodes is set to collapsed state. All other nodes in the serial sequence of nodes, which are hidden, are set to an expanded state. Rules may be contained within a Configuration file such as Configuration file 310 of view system 300 of FIG. 3.

View 810 is an illustration of another hierarchy with larger serial sequences in a summary view state. Hidden nodes 812 and hidden nodes 814 indicate the number of nodes in each respective serial sequence of nodes that are hidden in the current summary view. Leaf node 816 is a visual representation indicating the presence of multiple hidden paths extending from a parent node.

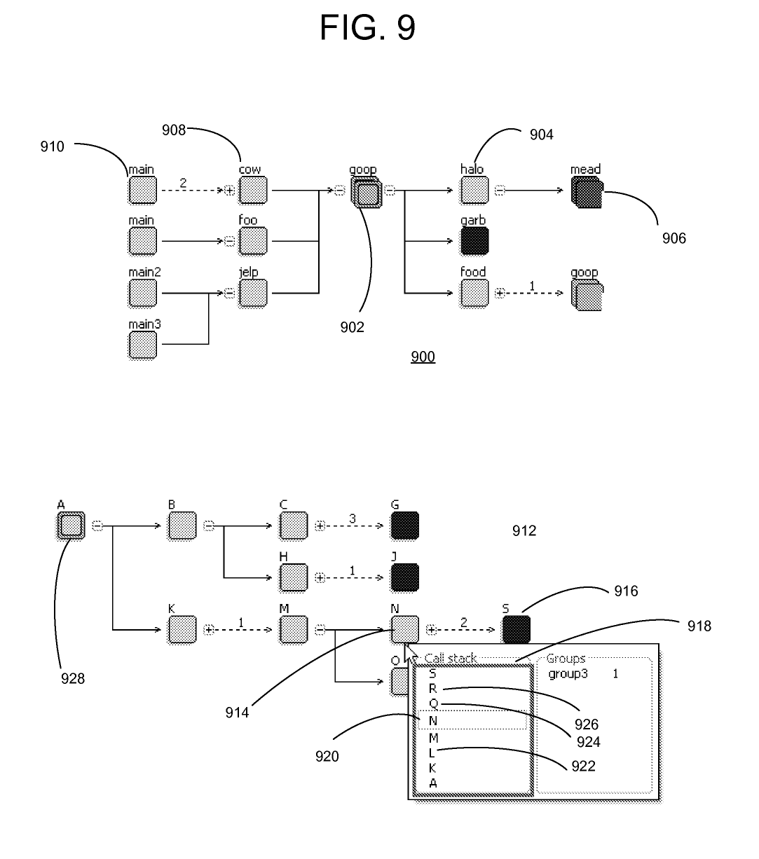

With reference to FIG. 9, a block diagram of summary views of nodes in a serial sequence of nodes, in accordance with various embodiments of the disclosure is presented. View 900 and view 912 are further example of view 400 of FIG. 4 with representation of collapsed nodes in a serial sequence of nodes in accordance with various embodiments of the disclosure.

View 900 is an illustration of a hierarchy in summary view state where a central root node, node 902 has hierarchies to the left and to the right side of the node. Node 904 is in expanded form with leaf node of node 906 completing the path. There are no intervening hidden nodes between node 904 and node 906.

Expanded node of node 908 is a first node to the left of node 902. A collapse control indicates node 908 may be expanded to reveal additional hidden nodes present in a path between node 908 and a leaf node of node 910. The disclosed process is applicable to symmetric node representations as well as asymmetric node representations in a typical tree view.

View 912 provides an example of a path information display in which a contracted node hides some of the associated descendent nodes. A separate visual entity can be used to show information about a particular node, including associated surrounding nodes that may be hidden. The view of the example is especially useful for obtaining a node path leading to a leaf node.

View 912 illustrates how a hierarchical path of a node such as node N 914, including hidden nodes of node L (list item 922), node Q (list item 924) and node R (list item 926), can be displayed using a list such as list 918.

List 918 provides a sequence listing of nodes. For example, a node of interest such as node 914 is provided in list 918 as list item 920 with adjacent nodes also listed. All nodes along a sequential path defined between node A 928 and node S 916 containing the identified node of interest node N 914 are included in entries of list 918. Using list 918 enables a user to display path information including nodes that were otherwise hidden when using a graphic representation in a tree view.

When implemented as a list, list 918 selections can be used to selectively include or exclude entries. For example, filters including a configurable parameter may be set to limit a predefined number of list items before and after a node of interest or another parameter may be set to not display portions of a path where the path branches to multiple children or multiple parents. The entries in the displayed list therefore follow the nodes of the serial sequence from a root node to an end node of the path containing the identified node of interest. Alternatively, a separate visual entity may display a subset of the tree hierarchy centered on a node of interest in a hierarchical tree form.

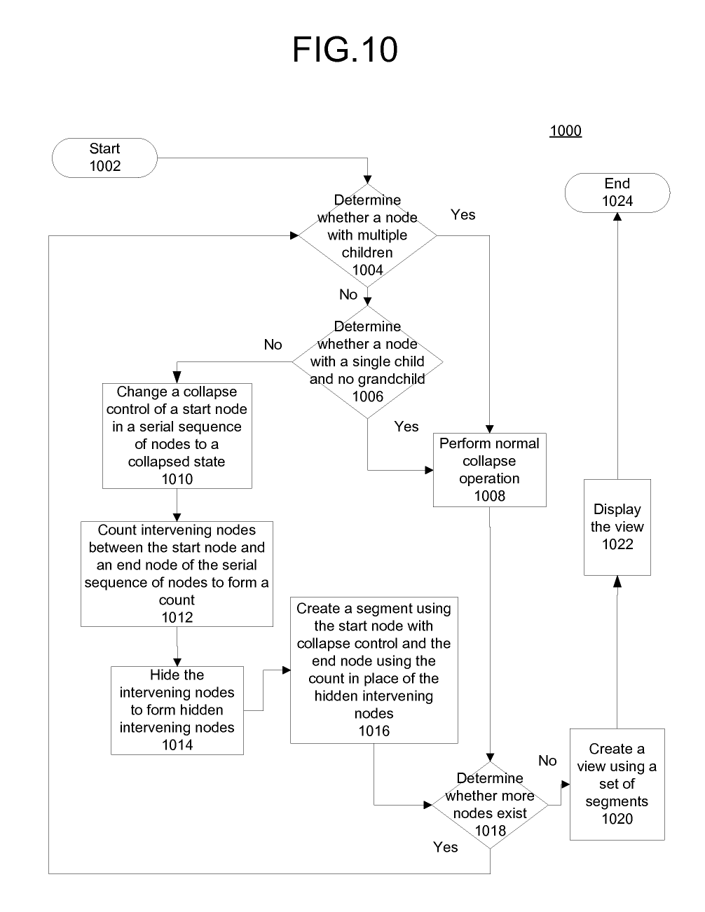

With reference to FIG. 10, a flowchart of a process for creating a view using nodes in a serial sequence of nodes, in accordance with various embodiments of the disclosure is presented. Process 1000 is an example of a process using view system 300 of FIG. 3.

Process 1000 starts (step 1002) and determines whether a node with multiple children is being processed (step 1004). When a determination is made that a node with multiple children is being processed process 1000 performs a normal collapse operation on the node (step 1008). Children and descendants of the collapsed node are hidden. Process 1000 skips ahead to perform step 1018.

When a determination is made that a node with multiple children is not being processed process 1000 determines whether a node with a single child and no grandchild is being processed (step 1006). When a determination is made that a node with a single child and no grandchild is being processed process 1000 performs a normal collapse operation on the node (step 1008). Children and descendants of the collapsed node are hidden as before and process 1000 skips ahead to perform step 1018.

When a determination is made that a node with a single child and no grandchild is not being processed process 1000 has determined the node is a node in a serial sequence of nodes. Process 1000 changes a collapse control of a start node to a collapsed state (step 1010). The start node is a first node in a serial sequence of nodes forming a head of path for the sequence. The collapse control is a visual representation of a user selectable control in a graphic user interface. The control is selected by a user to expand or contract node, depending upon a state of the control, representations associated with the node with the collapse control.

Process 1000 counts intervening nodes between the start node and an end node to form a count (step 1012). The end node is a leaf node at the end of the serial sequence of nodes that includes the start node. Process 1000 hides the intervening nodes to form hidden intervening nodes (step 1014). Each intervening node is set to expanded state but is hidden.

Process 1000 creates a segment using the start node with collapse control and the end node using the count in place of the hidden intervening nodes (step 1016). A numeric value of the count will be shown when the segment is displayed representing the number of hidden nodes between a display of the start node and the end node of the serial sequence of nodes.

A determination is made as to whether more nodes exist (step 1018). Responsive to a determination that more nodes exist, process 1000 loops back to perform step 1004 as before. Responsive to a determination that no more nodes exist, process 1000 creates a view using a set of segments (step 1020). The created view represents a set of segments previously formed, wherein the set is one or more segments comprising nodes and information associated with the nodes. Process 1000 displays the view (step 1022) and terminates thereafter (step 1024).

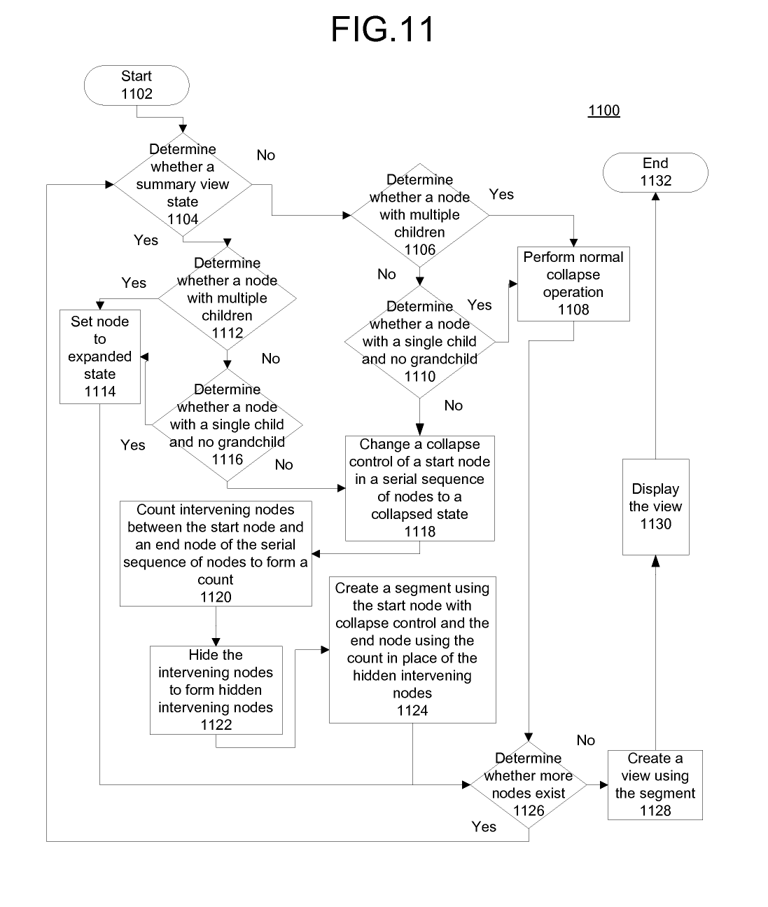

With reference to FIG. 11, a flowchart of a process for creating a summary view including nodes in a serial sequence of nodes, in accordance with various embodiments of the disclosure is presented. Process 1100 is an example of a process using view system 300 of FIG. 3.

Process 1100 starts (step 1102) and determines whether a summary view state exists (step 1104). Determining whether a summary view state exists is included within a receiving of hierarchy tree data operation. Responsive to a determination that a summary view state does not exist, process 1100 determines whether a node with multiple children is being processed (step 1106). When a determination is made that a node with multiple children is being processed process 1100 performs a normal collapse operation on the node (step 1108). Children and descendants of the collapsed node are hidden. Process 1100 skips ahead to perform step 1126.

When a determination is made that a node with multiple children is not being processed process 1100 determines whether a node with a single child and no grandchild is being processed (step 1110). When a determination is made that a node with a single child and no grandchild is being processed process 1100 performs a normal collapse operation on the node (step 1108). Children and descendants of the collapsed node are hidden as before and process 1100 skips ahead to perform step 1126. When a determination is made that a node with a single child and no grandchild is not being processed process 1100 performs step 1118.

When a determination is made that a summary view state exists, process 1100 determines whether a node with multiple children is being processed (step 1112). When a determination is made that a node with multiple children is being processed process 1100 sets the node to an expanded state (step 1114). When a determination is made that a node with multiple children is not being processed process 1100 determines whether a node with a single child and no grandchild is being processed (step 1116). When a determination is made that a node with a single child and no grandchild is being processed process 1100 sets the node to an expanded state (step 1114) as before. Process 1100 skips ahead to perform step 1126.

When a determination is made that a node with a single child and no grandchild is not being processed process 1100 changes a collapse control of a start node to a collapsed state (step 1118). The start node is a first node in a serial sequence of nodes forming a head of path for the sequence. The collapse control is a visual representation of a user selectable control in a graphic user interface. The control is selected by a user to expand or contract node, depending upon a state of the control, representations associated with the node with the collapse control.

Process 1100 counts intervening nodes between the start node and an end node to form a count (step 1120). The end node is a leaf node at the end of the serial sequence of nodes. Process 1100 hides the intervening nodes to form hidden intervening nodes (step 1122). Each intervening node is set to expanded state but is hidden.

Process 1100 creates a segment using the start node with collapse control and the end node using the count in place of the hidden intervening nodes (step 1124). A numeric value of the count will be shown when the segment is displayed representing the number of hidden nodes between a display of the start node and the end node of the serial sequence of nodes.

A determination is made as to whether more nodes exist (step 1126). Responsive to a determination that more nodes exist, process 1100 loops back to perform step 1104 as before. Responsive to a determination that no more nodes exist, process 1100 creates a view using the segments (step 1128). The created view represents a set of segments previously formed, wherein the set is one or more segments comprising nodes and information associated with the nodes. Process 1100 displays the view (step 1130) and terminates thereafter (step 1132).

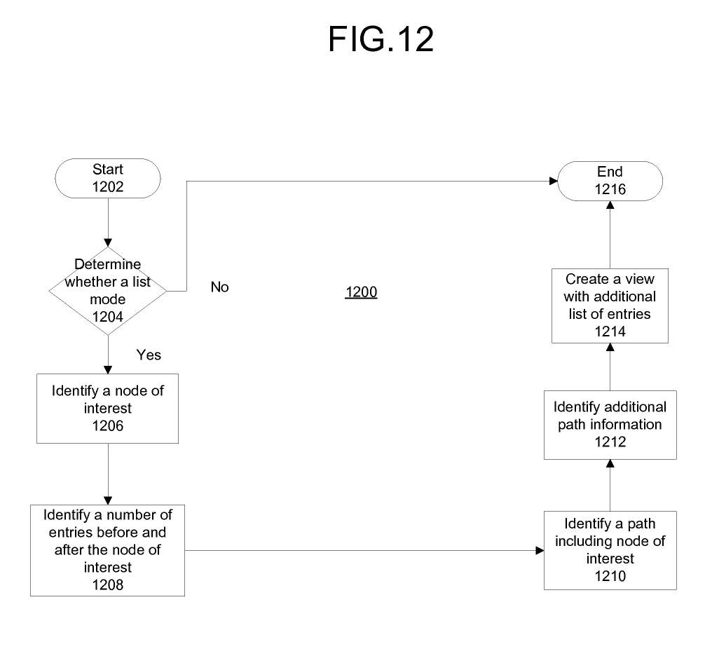

With reference to FIG. 12, a flowchart of a process for creating a view displaying additional node information using a serial sequence of nodes, in accordance with various embodiments of the disclosure is presented. Process 1200 is an example of a process using process 1100 of FIG. 11.

Process 1200 starts (step 1202) and determines whether a list mode exists (step 1204). Responsive to a determination that a list mode does not exist, process 1200 terminates (step 1216). Responsive to a determination that a list mode does exist, process 1200 identifies a node of interest (step 1206). Identification of a node of interest may be provided to process 1200 by a user response to a user interface prompt, input parameter at process startup or by a value as a saved response such as a Configuration file.

Process 1200 identifies a number of entries before and after the node of interest (step 1208). Identification of the number of entries before and after the node of interest may be made by a user response to a user interface prompt, input parameter at process startup or by a value in a saved response such as a Configuration file. A default value may be set as well as a dynamic input value provided through a user interface.

Process 1200 identifies a path including the node of interest (step 1210). A path is defined as a sequence of nodes from a root node to an end node wherein the node of interest is between the root node and the end node. The identified node may also be one of the root node or the end node. The identified path does not include branch nodes split from the direct path including the node of interest. When a branch is reached the list ends with node that has multiple children.

Process 1200 identifies additional path information (step 1212). Additional information includes start node, end node and intervening node information for each identified node of a serial sequence of nodes within the number of nodes limitation specified. Process 1200 creates a view with an additional list of entries (step 1214). The additional list of entries includes additional node information for all nodes in the path of the identified node of interest within the number of nodes limitation. For example, nodes that were defined as hidden as well as those displayed in a graphic tree representation are displayed as list entries according to proper path order enabling a user to see the node path. The list of entries may be limited by selectively providing a value during view creation or by a predetermined value prior to view creation.

The flowchart and block diagrams in the FIGS. 1-12 illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method comprising:
receiving hierarchical tree data;
determining whether a node is a start node of a serial sequence of nodes;
responsive to a determination that the node is a start node of a serial sequence of nodes, changing a collapse control of the start node in the serial sequence of nodes to a collapsed state;
counting intervening nodes between the start node and an end node of the serial sequence of nodes to form a count;
hiding the intervening nodes to form hidden intervening nodes;
creating a segment using the start node with collapse control and the end node using the count in place of the hidden intervening nodes; and
creating a hierarchical tree view using the segment, wherein one or more actions of the method are performed by a computing device comprising a processor executing program instructions stored in a non-transitory storage medium.

2. The method of claim 1 wherein receiving hierarchical tree data further comprises:
determining whether the hierarchical tree data is to be presented in a summary view state;
responsive to a determination that the hierarchical tree data is to be presented in a summary view state, determining whether a node with multiple children exists;
responsive to a determination that a node with multiple children exists, setting the node to expanded state;
responsive to a determination that a node with multiple children does not exist, determining whether a node with a single child and no grandchild exists;
responsive to a determination that a node with a single child and no grandchild exists, setting the node to expanded state; and
determining whether more nodes exist.

3. The method of claim 2 further comprising:
responsive to a determination that the hierarchical tree data is not to be presented in a summary view, determining whether a node with multiple children exists;
responsive to a determination that a node with multiple children exists, performing a normal collapse operation;
responsive to a determination that a node with multiple children does not exist, determining whether a node with a single child and no grandchild exists;
responsive to a determination that a node with a single child and no grandchild exists, performing a normal collapse operation; and
determining whether more nodes exist.

4. The method of claim 1 wherein creating a view using the segment further comprises: determining whether a list mode exists.

5. The method of claim 4 wherein responsive to a determination that a list mode exists further comprises:
identifying a node of interest;
identifying a number of entries before and after the node of interest; and
identifying a path including the node of interest.

6. The method of claim 5 wherein identifying a path including the node of interest further comprises:
identifying additional node information; and
creating the view with the additional node information.

7. The method of claim 1 further comprising: displaying the view.

8. A non-transitory computer program product comprising:
a computer recordable-type media containing computer executable program code stored thereon, the computer executable program code comprising:
computer executable program code for receiving hierarchical tree data;
computer executable program code for determining whether a node is a start node of a serial sequence of nodes;
computer executable program code responsive to a determination that the node is a start node of a serial sequence of nodes for changing a collapse control of the start node in the serial sequence of nodes to a collapsed state;
computer executable program code for counting intervening nodes between the start node and an end node of the serial sequence of nodes to form a count;
computer executable program code for hiding the intervening nodes to form hidden intervening nodes;
computer executable program code for creating a segment using the start node with collapse control and the end node using the count in place of the hidden intervening nodes; and
computer executable program code for creating a hierarchical tree view using the segment.

9. The non-transitory computer program product of claim 8 wherein computer executable program code for receiving hierarchical tree data further comprises:
computer executable program code for determining whether the hierarchical tree data is to be presented in a summary view state;
computer executable program code responsive to a determination that the hierarchical tree data is to be presented in the summary view state, for determining whether a node with multiple children exists;
computer executable program code responsive to a determination that a node with multiple children exists, for setting the node to expanded state;
computer executable program code responsive to a determination that a node with multiple children does not exist, for determining whether a node with a single child and no grandchild exists;
computer executable program code responsive to a determination that a node with a single child and no grandchild exists, for setting the node to expanded state; and
computer executable program code for determining whether more nodes exist.

10. The non-transitory computer program product of claim 9 wherein computer executable program code responsive to a determination that the hierarchical tree data is no to be presented in a summary view state, further comprises:
computer executable program code for determining whether a node with multiple children exists;
computer executable program code responsive to a determination that a node with multiple children exists, for performing a normal collapse operation;
computer executable program code responsive to a determination that a node with multiple children does not exist, for determining whether a node with a single child and no grandchild exists;
computer executable program code responsive to a determination that a node with a single child and no grandchild exists, for performing a normal collapse operation; and
computer executable program code for determining whether more nodes exist.

11. The non-transitory computer program product of claim 8 wherein computer executable program code for creating the view using the segment further comprises:
computer executable program code for determining whether a list mode exists.

12. The non-transitory computer program product of claim 11 wherein computer executable program code responsive to a determination that the list mode exists further comprises:
computer executable program code for identifying a node of interest;
computer executable program code for identifying a number of entries before and after the node of interest; and
computer executable program code for identifying a path including the node of interest.

13. The non-transitory computer program product of claim 12 wherein computer executable program code for identifying a path including the node of interest further comprises:
computer executable program code for identifying additional node information; and
computer executable program code for creating the view with the additional node information.

14. The non-transitory computer program product of claim 8 further comprising:
computer executable program code for displaying the view.

15. An apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
receive hierarchical tree data;
determine whether a node is a start node of a serial sequence of nodes;
responsive to a determination that the node is a start node of a serial sequence of nodes, change a collapse control of the start node in the serial sequence of nodes to a collapsed state;
count intervening nodes between the start node and an end node of the serial sequence of nodes to form a count;
hide the intervening nodes to form hidden intervening nodes;
create a segment using the start node with collapse control and the end node using the count in place of the hidden intervening nodes; and
create a hierarchical tree view using the segment.

16. The apparatus of claim 15 wherein the processor unit executes the computer executable program code to direct the apparatus to receive hierarchical tree data further directs the apparatus to:
determine whether the hierarchical tree data is to be presented in a summary view state;
responsive to a determination that the hierarchical tree data is to be presented in a summary view state, determine whether a node with multiple children exists;
responsive to a determination that a node with multiple children exists, set the node to expanded state;
responsive to a determination that a node with multiple children does not exist, determine whether a node with a single child and no grandchild exists;
responsive to a determination that a node with a single child and no grandchild exists, set the node to expanded state; and
determine whether more nodes exist.

17. The apparatus of claim 16 wherein the processor unit executes the computer executable program code responsive to a determination that the hierarchical tree data is not to be presented in a summary view state, to direct the apparatus to:
determine whether a node with multiple children exists;
responsive to a determination that a node with multiple children exists, perform a normal collapse operation;
responsive to a determination that a node with multiple children does not exist, determine whether a node with a single child and no grandchild exists;
responsive to a determination that a node with a single child and no grandchild exists, perform a normal collapse operation; and
determine whether more nodes exist.

18. The apparatus of claim 15 wherein the processor unit executes the computer executable program code to create a view using the segment further directs the apparatus to:
determine whether a list mode exists.

19. The apparatus of claim 18 wherein the processor unit executes the computer executable program code responsive to a determination that the list mode exists further directs the apparatus to:
identify a node of interest;
identify a number of entries before and after the node of interest; and
identify a path including the node of interest.

20. The apparatus of claim 19 wherein the processor unit executes the computer executable program code to identify a path including the node of interest further directs the apparatus to:
identify additional node information; and
create the view with the additional node information.
